(19) United States
(12) Patent Application Publication
(10) Pub. No.: US 2017/0205064 A1
(43) Pub. Date: Jul. 20, 2017

(54) LED LAMP

(71) Applicant: AVATAR INDUSTRIAL LTD, Foshan (CN)

(72) Inventors: Xuanrui Liao, Foshan (CN); Jun Chen, Foshan (CN); Yongjian Tan, Foshan (CN)

(21) Appl. No.: 15/324,271

(22) PCT Filed: Jan. 27, 2015
(86) PCT No.: PCT/CN2015/071642

§ 371 Date: Jan. 6, 2017

(30) Foreign Application Priority Data
Aug. 15, 2014 (CN) 201420464589.6

(51) Int. Cl. F21V 29/70; F21V 7/04; F21V 29/89; F21V 3/04; F21V 17/12; F21V 5/04; F21V 23/06

(52) U.S. Cl. CPC F21V 29/70; F21V 5/04; F21V 7/04; F21V 23/06; F21V 3/0418; F21V 17/12; F21V 29/89; F21Y 2105/00

(57) ABSTRACT

An LED lamp includes an insulated heat-dissipating shell, a driving power supply, a reflecting shade, a light source plate, a lens and an upper cover. Output of the driving power supply connects to contact pins, and its input connects to guide pin. The bottom of the shell is provided with an accommodating cavity for the driving power supply. The bottom of the cavity is provided with mounting holes for the guide pins. Outer wall of the reflecting shade is fitted with the inner wall of the shell, and the reflecting shade includes the heat-dissipating cover body and a base plate. The light source plate is fixed to the base plate, and the contact pin is electrically connected with the light source plate through the through hole. The upper cover has an opening in the middle and the lens is fixed to the opening in the middle of the upper cover.

### RELATED APPLICATIONS

The present application is a national stage entry according to 35 U.S.C. §371 of PCT application No.: PCT/CN2015/071642 filed on Jan. 27, 2015, which claims priority from China Patent application No.: 201420464589.6 filed on Aug. 15, 2014, and is incorporated herein by reference in its entirety.

### TECHNICAL FIELD

Various embodiments relates to the technical field of LED, in particular to an LED LAMP.

### BACKGROUND

Light-emitting diode (LED) is a solid-state semiconductor device that converts electric energy into the visible light, which can directly convert the electricity into light. The heart of LED is a semiconductor chip with one end attached to a rack (the end is negative); the other end connects to the positive terminal of the power, and the whole chip is packaged by epoxy resin.

Ordinary LED lamp (especially the downlight) consists of a light source, a substrate, the heat-dissipating component, a driving power supply, an outer shell, the reflecting component and a lens, wherein the light source can be PCB (printed circuit board) or COB (chip-on-board). The current LED lamp has the following defects: 1. Ordinary LED lamp needs to fix the light source with substrate and making the heat-dissipating component contact with the substrate for heat dissipation; the heat-dissipating component is generally designed with a larger space for fully contacting with air, which will cause the complete lamp taking up a greater space; 2. Link between the driving power supply and the light source often uses the lead wire or cable on the substrate, which will lead to a relatively complex internal structure, with the requirement of arranging the lead wire therein or carefully welding the cable; 3. Circuit is generally controlled by reflecting component, especially the reflecting-cup type LED. Since the focusing and glow effect of light source depends on the curved surface angle of the reflecting shade cup, the LED lamps with different specifications require the reflecting shade components with respective specifications; and the manufacturing cost of reflecting component is usually higher, leading to increase on the manufacturing cost of LED lamp.

### SUMMARY

Various embodiments provide an LED lamp, which can ensure the heat dissipation effect and meanwhile save a lot of spaces, capable of regular mass production, and save manufacturing cost.

According to various embodiments, an LED lamp includes an insulated heat-dissipating shell, a driving power supply, a reflecting shade, a light source plate, a lens and an upper cover, wherein, the driving power supply includes input and outputs, the output connects to a pair of contact pins, and the input connects to a pair of guide pins; the bottom of said insulated heat-dissipating shell is provided with an accommodating cavity for disposing the driving power supply; The bottom of the accommodating cavity is provided with a pair of mounting holes matching with the guide pins, through which the pair of guide pins pass; said reflecting shade is located inside the insulated heat-dissipating shell, and the inner wall thereof is fitted closely with the inner wall of the insulated heat-dissipating shell, the reflecting shade includes the heat-dissipating cover body and a base plate; both the body and the base plate are molded in one-piece, with a pair of through holes provided on the base plate, and the light source plate is fixed to the base plate, and the pair of contact pins at the output of the driving power supply is electrically connected with the light source plate through the through holes; said upper cover has an opening in the middle and said lens is fixed to the opening in the middle of the upper cover, and the upper cover is detachably connected with the top of a glass cover.

In various embodiments, said heat-dissipating cover body is a trumpet structure of the shape having small-top and big-bottom, and said base plate is located at the lower end of the heat-dissipating cover body.

In various embodiments, said light source plate is PCB or COB.

In various embodiments, said heat-dissipating cover body is a metal cover body.

In various embodiments, said upper cover is provided with external thread on its outside, inside the glass cover top is provided with internal thread matching with the external thread, and said upper cover and glass cover can achieve the detachable connection by the internal and external threads.

In various embodiments, the edge of the upper cover is provided with at least three blocks, the upper end of glass cover provides slots matching with the blocks at the corresponding position to the blocks, and said upper cover and glass cover achieve detachable connection by fastening the blocks into the slots.

In various embodiments, wherein said light source plate is welded and fixed to the base plate.

In various embodiments, said pair of through holes are provided on the base plate symmetrically by taking the axis of reflecting shade as the symmetric axis.

In various embodiments, the LED lamp further includes a pair of pins, said pins is sleeve connected to the guide pins, with its top end riveted to the bottom of the glass cover.

The present disclosure may have beneficial effects as follows:

1. The present disclosure directly fix the light source plate onto the base plate of the reflecting shade, realizing that the integration of the substrate, the heat-dissipating cover and the reflecting shade. Owing to the sufficient extension surface, the heat dissipation effect is ensured and meanwhile a lot of spaces is saved by using the reflecting shade as the heat-dissipating component; the substrate is actually omitted, and all the functional components are the standard module which can be mass-produced in regular;

2. In the LED lamp of the present disclosure, through holes are provided on the base plate of the reflecting shade; the driving power supply uses the contact pin as the output of electrodes and can be electrically connected directly to the light source plate through the through holes; therefore, the design saves more spaces, making the interior electrical structure simpler and compact;

3. In the present disclosure, due to the integration of reflecting shade and substrate, heat-dissipating cover and reflecting shade lamp, the LED lamp can realize mass production and reduce the cost of production.

4. The present disclosure uses the lens to control the focusing effects of light source, and control the light guide structure of the lens in accordance with the required reflection effect so as to realize light effect control.

### DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a structural view of the LED lamp of the present disclosure.

FIG. 2 is an exploded view of the LED lamp of the present disclosure.

FIG. 3 is a structural view of the preferred LED of the present disclosure.

### DETAILED DESCRIPTION

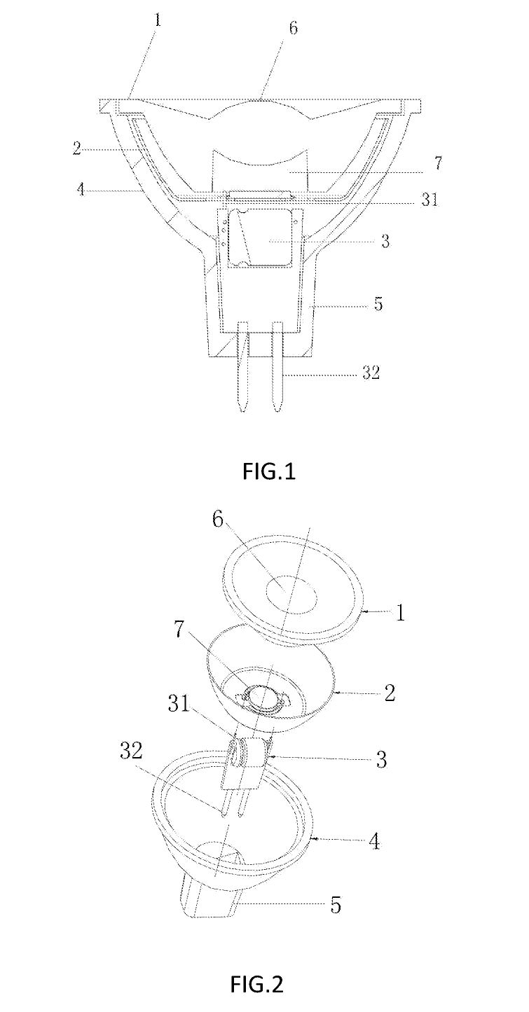

As shown in FIGS. 1 and 2, an LED lamp of the present disclosure includes an insulated heat-dissipating shell 4, a driving power supply 3 a reflecting shade 2, a light source plate, a lens 6 and an upper cover 1. The driving power supply 3 includes input and output, wherein its output connects to a pair of contact pins 31, and its input connects to a pair of guide pin 32; the bottom of said insulated heat-dissipating shell 4 provides an accommodating cavity 5 for disposing the driving power supply 3. The bottom of the accommodating cavity 5 has a pair of mounting holes (not shown) matching with the guide pins, through which the pair of guide pins pass; the said reflecting shade 2 is located inside the insulated heat-dissipating shell 4, and its inner wall is fitted closely with the inner wall of insulated heat-dissipating shell 4, the reflecting shade includes the heat-dissipating cover body and base plate, both the body and the base plate are integrated as one-piece, with a pair of through holes (not shown) provided on the base plate, and the light source plate 7 is fixed to the base plate, and the pair of contact pins 31 at the output of the driving power supply 3 is electrically connected with the light source plate 7 through the through holes; said upper cover 1 has an opening in the middle, said lens 6 is fixed to the opening in the middle of the upper cover 1, and the upper cover 1 is detachably connected with the top the detachable connection of upper cover 1 is located on the top of insulated heat-dissipating shell 4.

On the basis of the above solution, as a preferred embodiment, said heat-dissipating cover body is a trumpet structure of the shape having small-top and big-bottom, and said base plate is located at the lower end of the heat-dissipating cover body. Adoption of the structure makes the extension surface of the heat-dissipating cover, i.e. reflecting shade, is sufficient, so that the heat dissipation effect is ensured.

The light source plate 7 of the present disclosure is the PCB or COB commonly used in the LED lamp.

As a preferred solution of the present disclosure, said heat-dissipating cover body is a metal cover body. Aluminum heat-dissipating cover can effectually achieve the heat dissipation effect and also has a good reflective effect.

In the present disclosure, the upper cover and the glass cover adopt the detachable connection methods, and one of which is achieved by detachably connecting the upper cover 1 and the insulated heat-dissipating shell 4 using the external and internal threads, wherein the external thread (not shown) is provided at outside of the upper cover and the internal thread (not shown) that matching with the external thread, is provided inside the top of insulated heat-dissipating shell 4. Another method of detachable connection is: the edge of the upper cover 1 is provided with at least three blocks (not shown); the upper end of the insulated heat-dissipating shell 4 is provided with slots (not shown) matching with the blocks at the corresponding position to the blocks, and said upper cover and glass cover achieve detachable connection by fastening the blocks into the slots. It is understood that the present disclosure does not limit to the above the two detachable connections, but also includes any other connection with identical functionality.

On the basis of the above scheme, as a preferred embodiment, the light source plate 7 is welded and fixed to the base plate.

On the basis of the above scheme, as a preferred embodiment, said pair of through holes are provided on the base plate symmetrically by taking the axis of reflecting shade 2 as the symmetric axis. Contact pin 31 at the output of the driving power supply 3 can be electrically connected directly to the light source plate 7 through the through holes; therefore, the design saves more spaces, making the interior electrical structure simpler and compact;

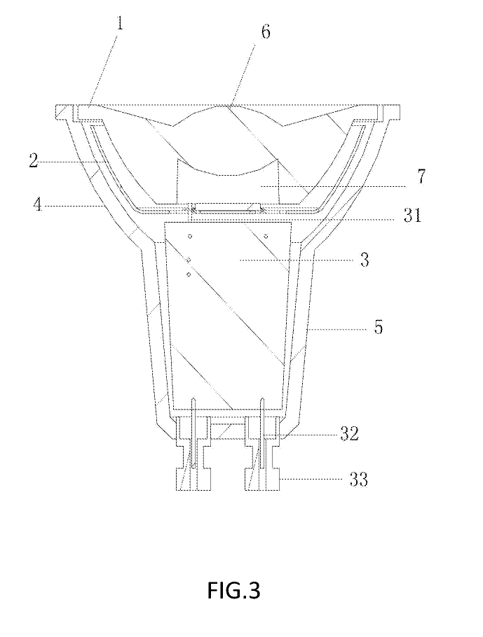

As shown in FIG. 3, on the basis of the above scheme, as a preferred embodiment, the LED lamp further includes a pair of pins 33, and said pins 33 is fastened onto the guide pin 32, with its top end riveted to the bottom of the glass cover 4.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED lamp comprising:
an insulated heat-dissipating shell,
a driving power supply,
a reflecting shade,
a light source plate,
a lens and an upper cover,
wherein, the driving power supply includes input and outputs, the output connects to a pair of contact pins, and the input connects to a pair of guide pins; the bottom of said insulated heat-dissipating shell is provided with an accommodating cavity for disposing the driving power supply; the bottom of the accommodating cavity is provided with a pair of mounting holes matching with the guide pins, through which the pair of guide pins pass; said reflecting shade is located inside the insulated heat-dissipating shell, and the inner wall thereof is fitted closely with the inner wall of the insulated heat-dissipating shell, the reflecting shade includes the heat-dissipating cover body and a base plate; both the body and the base plate are molded in one-piece, with a pair of through holes provided on the base plate, and the light source plate is fixed to the base plate, and the pair of contact pins at the output of the driving power supply is electrically connected with the light source plate through the through holes; said upper cover has an opening in the middle and said lens is fixed to the opening in the middle of the upper cover, and the upper cover is detachably connected with the top of a glass cover.

2. The LED lamp of claim 1, wherein said heat-dissipating cover body is a trumpet structure of the shape having small-top and big-bottom, and said base plate is located at the lower end of the heat-dissipating cover body.

3. The LED lamp of claim 1, wherein the light source plate is PCB or COB.

4. The LED lamp of claim 1, wherein said heat-dissipating cover body is a metal cover body.

5. The LED lamp of claim 1, wherein said upper cover is provided with external thread on its outside, inside the glass cover top is provided with internal thread matching with the external thread, and said upper cover and glass cover can achieve the detachable connection by the internal and external threads.

6. The LED lamp of claim 1, wherein the edge of the upper cover is provided with at least three blocks, the upper end of said glass cover is provided with slots matching with the blocks at the corresponding position to the blocks, and said upper cover and glass cover achieve detachable connection by fastening the blocks into the slots.

7. The LED lamp of claim 1, wherein the light source plate is welded and fixed to the base plate.

8. The LED lamp of claim 1, wherein said pair of through holes are provided on the base plate symmetrically by taking the axis of reflecting shade as the symmetric axis.

9. The LED lamp of claim 1, further comprising a pair of pins, wherein said pins is sleeve connected to the guide pins, with its top end riveted to the bottom of the glass cover.
